(19) United States
(12) Patent Application Publication
(10) Pub. No.: US 2017/0082852 A1
(43) Pub. Date: Mar. 23, 2017

(54) Optic Green Light Illumination System

(71) Applicant: CALIFORNIA INSTITUTE OF TECHNOLOGY, Pasadena, CA (US)

(72) Inventors: Calum I. TORRIE, Pasadena, CA (US); Kaitlin E. GUSHWA, Glendale, CA (US); Garilynn BILLINGSLEY, Pasadena, CA (US); Benjamin P. ABBOTT, Pasadena, CA (US); Eduardo J. SANCHEZ, Los Angeles, CA (US)

(21) Appl. No.: 15/267,064

(22) Filed: Sep. 15, 2016

Related U.S. Application Data
(60) Provisional application No. 62/220,355, filed on Sep. 18, 2015.

(51) Int. Cl. G02B 27/00; F21V 33/00; F21V 21/34

(52) U.S. Cl. CPC G02B 27/0006; F21V 21/34; F21V 33/00; F21Y 2115/10

(57) ABSTRACT

A frame housing green LEDs can be positioned adjacent to a lens in order to illuminate the lens at a glancing angle. The green light allows better visualization of particulates on a surface of the lens. The particulates can then be removed with a polymer solution applied to the lens. The polymer traps the particulates, and can be removed from the lens to remove the particulates.

### CROSS REFERENCE TO RELATED APPLICATIONS

The present application claims priority to U.S. Provisional Patent Application No. 62/220,355, filed on Sep. 18, 2015, the disclosure of which is incorporated herein by reference in its entirety.

### STATEMENT OF INTEREST

This invention was made with government support under Grant No. PHY0757058 awarded by the National Science Foundation. The government has certain rights in the invention.

### TECHNICAL FIELD

The present disclosure relates to illumination systems. More particularly, it relates to an optic green light illumination system.

### SUMMARY

In a first aspect of the disclosure, a structure is described, the structure comprising: a frame surrounding an inner space; a plurality of green LEDs attached to the frame, the green LEDs oriented towards the inner space and configured to illuminate the inner space with green light.

In a second aspect of the disclosure, a method is described, the method comprising: positioning a frame with a plurality of green LEDs adjacent to a surface of a lens; illuminating the lens with the plurality of green LEDs at a glancing angle between the surface of the lens and green light emitted from the plurality of green LEDs, thereby illuminating particulates on the surface of the lens.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates an exemplary embodiment of a green light system.

FIGS. 2-3 illustrate an exemplary embodiment where the green LEDs encircle a lens.

FIG. 4 illustrates an exemplary flowchart of a method to detect and remove particulates from a lens.

### DETAILED DESCRIPTION

In order to effectively mitigate particulate contamination of optical elements, such as lenses, personnel need to see the particulates in situ—in the cleanrooms and vacuum chambers. A useful method to render the particulates more visible is with high intensity, grazing incident light. The present disclosure describes hand-held illumination arrays to assist personnel working in cleanrooms and in vacuum chambers, to see the particulate contamination so that the particulates can be removed. For example, the particulates can be removed with cleaning polymers such as First Contact™, clean room wipes, HEPA-vacuum cleaners, ion guns, etc.

The particulate illumination and imaging problem is particularly acute for transmissive optics due to reflections and due to the transmitted light. The present disclosure describes how personnel and cameras can see the surface contamination best with green light (the wavelength for peak photopic response). Seeing the surface contamination under the best conditions allows one to correctly assess the state of the optic and give all the information needed to decide whether to clean the optic or not. In certain applications, such as at the Laser Interferometer Gravitational-Wave Observatory (LIGO), the optics are used in combination with high powered lasers (up to about 200 W). In these applications, surface contamination left untreated can lead to laser irradiation damage in the optics, which can degrade performance of the optics and ultimately lead to early replacements.

In order to provide grazing incident light, the light source would normally need to be placed near the optic bezel and radially oriented. However, in certain applications, the suspension structures of the optics prevent this type of orientation for hand-held light sources. The presence of the suspension structures also can create some risk of impact damage to the optic surface, when trying to mount a source at the optic bezel with a radial orientation. To obviate these problems, the present disclosure describes a custom green LED light source which mounts to the face of a large suspension structure and provides bright, green, grazing incidence light on the optic face.

The light source described herein was tested at the LIGO Hanford site while the chambers were open. During the test, the grazing-incidence, green light was excellent at illuminating the dust on the optics. The green light illumination system allows to not only image the optic and count the dust on the optics, but also to decide which cleaning method to employ, and compare the effectiveness of the cleaning techniques. The amount of particulates can be tested before and after cleaning, and the effectiveness of a cleaning method can therefore be tested with the green light source described herein. During the test, it was demonstrated that using a light source at the green wavelength allows a human operator to see a greater amount of particulates compared to lights at other wavelengths, or even light comprising multiple wavelengths including green, such as a standard white light flashlight.

In some embodiments, such as at LIGO, lenses are used under vacuum conditions. During operation, a vacuum chamber may undergo pump down cycles, i.e. transitions from atmosphere to vacuum, as well as venting cycles, i.e. transitions from vacuum to atmosphere. These cycles cause particles to lift and migrate within the vacuum chambers, possibly landing on a lens. In addition, there is a finite, and not insignificant, amount of time between the removal of particulates from critical optical surfaces with a cleaning polymer, such as First Contact™, and a pump down cycle. As a consequence, there is a finite risk that a significant areal density of particulates may be found within the central region of a lens where the laser beam of LIGO is transmitted through. These particulates can lead to pin-hole damage to the optic coating of the lens.

After a limited number of pumping down and venting cycles, the integrated loss due to the damage on the optical coating becomes intolerable. Ideally, the particulates which migrate onto the critical optical surfaces should be removed after the pump down cycle. One approach to do so is to implement air knife systems to blow particulates off of some of the optical surfaces with air. It may also be possible to use in-vacuum air knife/nozzle systems for critical optical surfaces. These systems can be employed in conjunction with the optic green light illumination system as described in the present disclosure.

The concept is to create a hypersonic jet, or multiple jets, of ionized nitrogen (or air) directed at the critical optical surface. Alternatively, the jet may also be scanned across the optical surface.

A small vacuum system with a small (3″ dia.) suspended optic (single stage) can be used to test and optimize the parameters of such an air knife system. For example, the flow rate, pressures, stand-off distance, ion density, etc. can be adjusted to optimize the performance of the air knife system. Therefore, in some embodiments, the green light system of the present disclosure can be used together with an air knife system. The flow rate of the gas used to blow off the particulates can be adjusted, as well as the pressure of the gas, the distance between the gas jet and the optical lens, and the ion density of the gas. The jet is directed by a nozzle pointed at the optical lens. The green light can be used to observe the particulates and determine whether the air knife has successfully removed the required number of particulates in order the render the optical lens operationally safe.

In some embodiments, the illumination device of the present disclosure operates on lenses under ultra-high vacuum (UHV). For example, the LIGO operates a UHV system at pressures down to 1×10−9 Torr. LIGO's fused silica optics are 34 cm diameter×20 cm thick, weigh 40 kg, and have a High Reflectance (HR) coating consisting of alternating layers of silica & titanium doped tantala. The optics are designed to have very low intrinsic absorption and scatter; however, they are also highly sensitive to scatter and absorption loss induced by particulate contamination. LIGO utilizes a 200 W Nd:YAG continuous wave laser. The peak fluence at high power will be 96 W/mm² for the larger optics and up to 2000 W/mm² on some of the smaller optics.

During operation of the interferometers at LIGO, even low-level contaminants can induce pin-hole damage in the optic coatings, which would in turn affect the overall detector sensitivity. Even with stringent cleanliness protocols in place, higher than anticipated levels of contamination were found in assembly areas and inside vacuum chambers at both observatories.

At LIGO, the absorption requirements (≦0.1 ppm) are more restrictive than scattering requirements (≦5 ppm) for allowable particulate contamination. The requirements for the large fused silica optics are, for allowable absorption due to contamination, about 0.7 ppm.

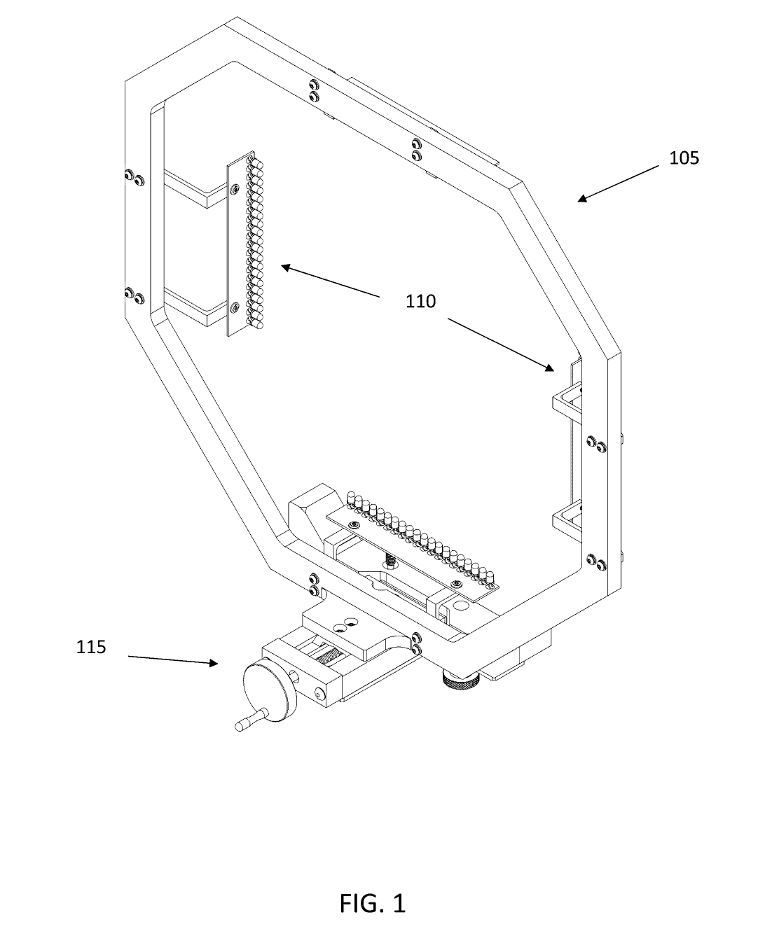

FIG. 1 illustrates an exemplary embodiment of a green light system. For example, a frame (105) is used as a support to attach green LEDs (110). The LEDs are oriented so as to illuminate an area, laterally to their position. An optical lens is placed within this area so as to be illuminated by green light at a grazing incidence angle. As known to the person of ordinary skill in the art, grazing incidence indicates illuminating light that is parallel or almost parallel to the lens surface. In other words, grazing or glancing incidence indicates a zero or very small angle between the lens surface and the illuminating light. In some embodiments, a sliding mechanism (115) can control the distance of the frame (105) from the lens, in order to adjust the incident light to be at a glancing angle.

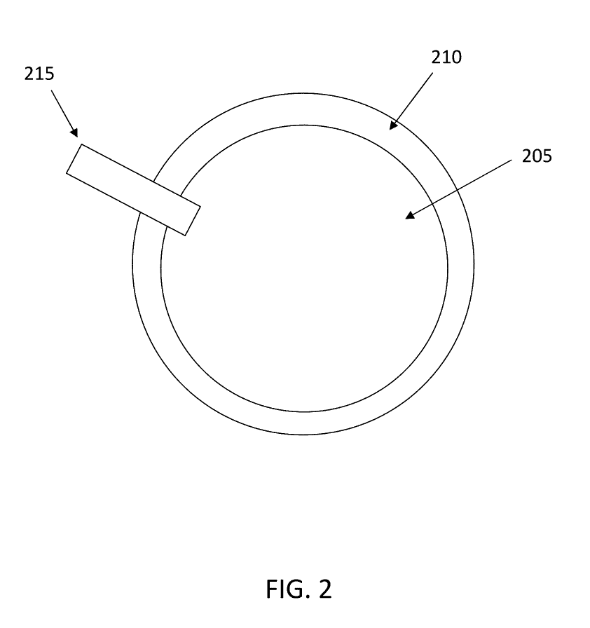

FIG. 2 illustrates an alternative embodiment to FIG. 1. In FIG. 2, a lens (205) is surrounded by ring of LEDs (210), the LEDs being attached to a frame. The frame also comprises the necessary electrical connection so as to power the LEDs. The LEDs can partly or completely occupy the frame in order to illuminate the lens. For example, the ring can comprise a plurality of green LEDs that completely encircles the lens at a glancing angle in order to render particulates more visible. In some embodiments, a gas nozzle (215) can direct gas at the lens, as discussed above, in order to remove particulates or prevent the particulates from settling on the lens. The particulates on the lens, rendered visible by the green illuminating system, can be removed with different methods, such as with the application and removal of a polymer that traps the particulates, for example a First Contact™ polymer.

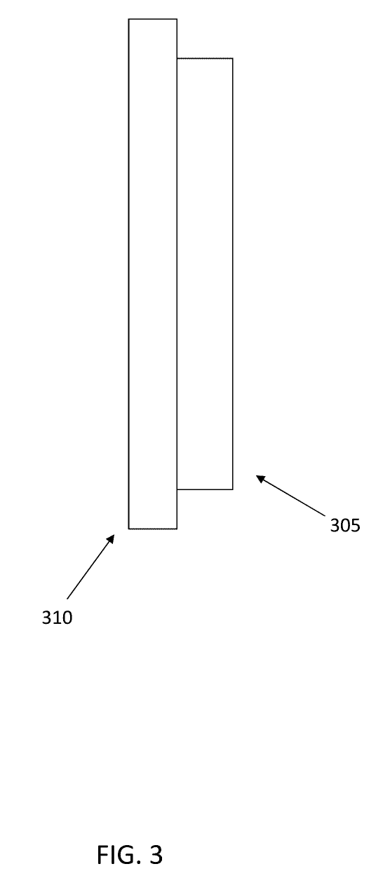

FIG. 3 illustrates a lateral view of the embodiment of FIG. 2, where a lens (305) is visible, with a frame (310) housing a plurality of green LEDs illuminating the lens (305).

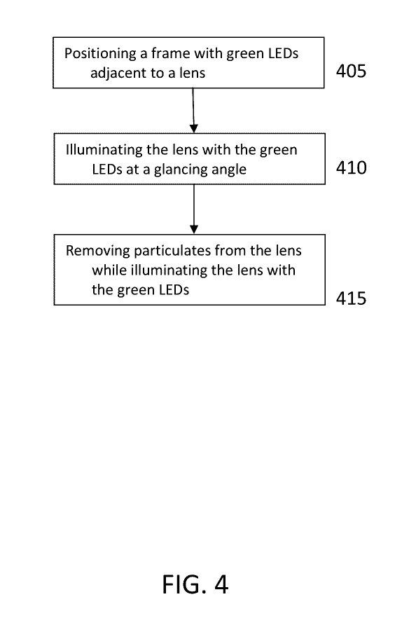

In some embodiments, as described in FIG. 4, the present disclosure describes a method to clean an optic lens, the method comprising positioning a frame with a plurality of green LED adjacent to a lens, illuminating the lens with green light at a glancing angle, and removing particulates on the lens while illuminating the lens with green light. For example, the particulates can be removed with a polymer solution. Once the polymer solution has dried, the polymeric film can be removed from the lens, having trapped particulates within for removal. In some embodiments, the method further comprises using a gas nozzle to remove particulates from the lens, or preventing particulates from settling onto the lens, for example during certain pumping cycles of a vacuum chamber in which the lens is housed.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A structure comprising:
a frame surrounding an inner space; and
a plurality of green LEDs attached to the frame, the green LEDs oriented towards the inner space and configured to illuminate the inner space with green light.

2. The structure of claim 1, wherein the frame is configured to surround a surface of the lens in the inner space.

3. The structure of claim 2, wherein the plurality of LEDs is configured to illuminate the surface of the lens at a glancing angle.

4. The structure of claim 3, wherein the plurality of LEDs entirely encircles surface of the lens.

5. The structure of claim 4, wherein the frame comprises a sliding mechanism to regulate a distance between the frame and the lens.

6. The structure of claim 5, further comprising a gas nozzle oriented towards the surface of the lens and configured to direct gas towards the surface of the lens.

7. The structure of claim 6, wherein the lens is under vacuum.

8. A method comprising:
positioning a frame with a plurality of green LEDs adjacent to a surface of a lens; and
illuminating the lens with the plurality of green LEDs at a glancing angle between the surface of the lens and green light emitted from the plurality of green LEDs, thereby illuminating particulates on the surface of the lens.

9. The method of claim 8, further comprising removing the particulates from the surface of the lens.

10. The method of claim 9, wherein removing the particulates comprises:
applying a polymer solution to the surface of the lens;
trapping the particulates with the polymer solution;
drying the polymer solution; and
removing the polymer solution with the trapped particulates.

11. The method of claim 10, wherein the lens is within a vacuum chamber, and further comprising directing a gas at the surface of the lens with a gas nozzle, thereby preventing settling of new particulates on the surface of the lens during pumping down of the vacuum chamber.
